(19) United States
(12) Patent Application Publication
(10) Pub. No.: US 2026/0135034 A1
(43) Pub. Date: May 14, 2026

(54) CAPACITOR AND METHOD FOR MANUFACTURING SAME

(71) Applicant: INDUSTRY-ACADEMIC COOPERATION FOUNDATION, YONSEI UNIVERSITY, Seoul (KR)

(72) Inventors: Jong Ill HONG, Seoul (KR); Min Hyuk PARK, Seoul (KR); Geun Hyeong PARK, Seoul (KR); Jae Wook LEE, Seoul (KR); Yong Hyeon CHO, Seoul (KR)

(21) Appl. No.: 19/003,335

(22) Filed: Dec. 27, 2024

(30) Foreign Application Priority Data
Nov. 11, 2024 (KR) 10-2024-0159452
Dec. 26, 2024 (KR) 10-2024-0196742

(51) Int. Cl. H01G 4/008; H01G 4/12; H01G 4/33

(52) U.S. Cl. CPC H01G 4/008; H01G 4/1236; H01G 4/33

(57) ABSTRACT

An embodiment provides a low-voltage behavior capacitor including a silicon substrate, a lower electrode positioned on the silicon substrate and including a titanium nitride with a preferred orientation control, a dielectric layer positioned on the lower electrode and including a hafnium-zirconium composite oxide, and an upper electrode positioned on the dielectric layer.

### BACKGROUND

The disclosure relates to a capacitor, and more specifically, to a capacitor capable of operating at low voltage and a method of manufacturing the same.

Currently, artificial intelligence (AI) technology is mainly implemented through semiconductor-based devices, and these devices provide high performance but consume significant energy. In particular, in fields requiring high-speed calculations such as AI, the issue of power consumption has emerged as a serious issue, and accordingly, the development of next-generation semiconductor devices capable of operating at low power while operating at high speed is urgent.

Ultra-thin film capacitors based on antiferroelectrics can simultaneously provide large-capacity data storage, fast operation speed, and non-volatility characteristics, and are thus attracting attention as a key technology in the semiconductor industry in the near future. In particular, capacitors having a metal/antiferroelectric/metal structure can induce an electric field inside the antiferroelectric through different work functions of the lower electrode, and can be utilized as memory devices such as Ferroelectric Random-Access Memory (FeRAM). In addition, in the junction structure of antiferroelectrics and ferromagnets, the interfacial charge can be induced and applied as a spin logic device through spin-charge conversion.

Hf₁₋ₓZrₓO₂ thin films are representative materials that exhibit antiferroelectricity, and the non-polar tetragonal phase can be transformed into the polar orthorhombic phase through electrically induced ferroelectricity. However, it has been reported that a high electric field of 2 MV/cm or more is required in this process, which is a practical limitation for using it as a low-power device.

In order to develop Hf₁₋ₓZrₓO₂-based antiferroelectric devices capable of low-power operation, it is essential to secure characteristics that enable switching even at low electric fields. However, specific research to implement these characteristics is still in the initial stage, and research to solve this problem is continuously needed.

### SUMMARY

An aspect of the disclosure is to provide a capacitor capable of operating at low power and a method for manufacturing the same.

The aspect of the disclosure is not limited to that mentioned above, and other aspects not mentioned will be clearly understood by those skilled in the art from the description below.

An embodiment of the disclosure provides a capacitor.

In an embodiment of the disclosure, a capacitor includes: a silicon substrate; a lower electrode positioned on the silicon substrate, the lower electrode including a titanium nitride with a preferred orientation control; a dielectric layer including a hafnium-zirconium composite oxide positioned on the lower electrode; and an upper electrode positioned on the dielectric layer.

In addition, in an embodiment of the disclosure, the preferred orientation of the titanium nitride may be oriented along a (1,1,1) crystal plane.

In addition, in an embodiment of the disclosure, the hafnium-zirconium composite oxide may be represented by Chemical Formula 1:

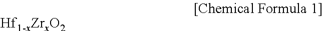

(the X satisfies 0.7≤x<1).

In addition, in an embodiment of the disclosure, the dielectric layer may be antiferroelectric.

In addition, in an embodiment of the disclosure, the thickness of the lower electrode may be 15 nm to 25 nm.

In addition, in an embodiment of the disclosure, the thickness of the dielectric layer may be 4.5 nm to 5.3 nm.

In addition, in an embodiment of the disclosure, the upper electrode may include at least one from the group consisting of titanium nitride and molybdenum.

Another embodiment of the disclosure provides a method for manufacturing a capacitor.

In an embodiment of the disclosure, the method for manufacturing a capacitor may include: forming a lower electrode comprising a titanium nitride having a preferred orientation control by first deposition from a titanium precursor and a nitriding agent on a silicon substrate; forming a dielectric layer comprising a hafnium-zirconium composite oxide by second deposition from a hafnium precursor compound and a zirconium precursor compound on the lower electrode in the presence of ozone; and forming an upper electrode by third deposition on the dielectric layer.

In addition, in an embodiment of the disclosure, the preferred orientation of the titanium nitride may be oriented along a (1,1,1) crystal plane.

In addition, in an embodiment of the disclosure, the hafnium-zirconium composite oxide may be represented by Chemical Formula 1:

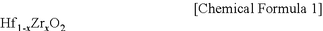

(the X satisfies 0.7≤x<1).

In addition, in an embodiment of the disclosure, in the forming of the lower electrode, the first deposition may be performed using a plasma atomic layer deposition method.

In addition, in an embodiment of the disclosure, in the forming of the dielectric layer, the second deposition may be performed by a thermal atomic layer deposition method at a temperature of 200° C. to 300° C.

In addition, in an embodiment of the disclosure, in the forming of the upper electrode, the third deposition may be performed by sputtering using plasma power.

In addition, in an embodiment of the disclosure, the method may further include, after the forming of the upper electrode, performing an annealing process after metallization under conditions of 30 to 300 seconds at a temperature of 400 to 500° C.

A capacitor according to an embodiment of the disclosure can provide an effect of implementing an antiferroelectric that is switchable even at low voltage by preventing oxidation of an electrode that occurs during an atomic layer deposition method of an HZO thin film.

In addition, a capacitor according to an embodiment of the disclosure can minimize device to device variation that occurs in a polycrystalline HZO thin film due to miniaturization of a device, and can provide an effect of being applicable to a three-dimensional structure and having suitability for a back-end-of-line process that requires a process temperature of 400 degrees or less.

The effects of the disclosure are not limited to the effects described above, and should be understood to include all effects that are inferable from the configuration of the disclosure described in the detailed description or claims of the disclosure. The aspect of the disclosure is not limited to that mentioned above, and other aspects not mentioned will be clearly understood by those skilled in the art from the description below.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a flow chart showing the steps of a capacitor manufacturing method according to an embodiment of the disclosure;

FIGS. 2A, 2B, and 2C are each a schematic diagram showing the process of a capacitor manufacturing method according to an embodiment of the disclosure;

FIGS. 3A and 3B are each a schematic diagram showing a capacitor according to an embodiment of the disclosure when the upper electrode is TiN or Mo;

FIG. 4 is a schematic diagram showing a PEALD process for depositing TiN electrodes;

FIG. 5 is an XRD graph confirming the orientation of the formed TiN electrode;

FIG. 6 is a P-V graph when the upper electrode is TiN in 5.2 nm-Hf₁₋ₓZrₓO₂;

FIG. 7 is a J-V graph when the upper electrode is TiN in 5.2 nm-Hf₁₋ₓZrₓO₂;

FIG. 8 is a leakage current density graph according to voltage when the upper electrode is TiN in 5.2 nm-Hf₁₋ₓZrₓO₂;

FIG. 9 is a graph of the dielectric constant as a function of voltage when the upper electrode is TiN in 5.2 nm-Hf₁₋ₓZrₓO₂;

FIG. 10 is a P-V graph analyzing the endurance characteristics when the upper electrode is TiN in 5.2 nm-Hf₁₋ₓZrₓO₂;

FIG. 11 is a J-V graph analyzing the endurance characteristics when the upper electrode is TiN in 5.2 nm-Hf₁₋ₓZrₓO₂;

FIGS. 12A and 12B are a P-V graph and a J-V graph when the upper electrode is TiN in 4.5 nm-Hf₁₋ₓZrₓO₂ and X is 0.9;

FIGS. 13A and 13B are a P-V graph and a J-V graph when the upper electrode is TiN in 4.5 nm-Hf₁₋ₓZrₓO₂ and X is 0.8;

FIGS. 14A and 14B are a P-V graph and a J-V graph when the upper electrode is TiN in 4.5 nm-Hf₁₋ₓZrₓO₂ and X is 0.7;

FIGS. 15A and 15B are a P-V graph and a J-V graph when the upper electrode is Mo and X is 0.9 in 4.5 nm-Hf₁₋ₓZrₓO₂;

FIGS. 16A and 16B are a P-V graph and a J-V graph when the upper electrode is Mo and X is 0.8 in 4.5 nm-Hf₁₋ₓZrₓO₂;

FIGS. 17A and 17B are a P-V graph and a J-V graph when the upper electrode is Mo and X is 0.7 in 4.5 nm-Hf₁₋ₓZrₓO₂;

FIGS. 18A and 18B are a P-V and a J-V graph at a voltage of 1.4 V when the upper electrode is TiN and X is 0.7-0.9 in 4.5 nm-Hf₁₋ₓZrₓO₂;

FIGS. 19A and 19B are a P-V and a J-V graph at a voltage of 1.4 V when the upper electrode is Mo and X is 0.7-0.9 in 4.5 nm-Hf₁₋ₓZrₓO₂;

FIGS. 20A, 20B, 20C, and 20D are P-V, J-V graphs extracted using the dynamic leakage current compensation (DLCC) method;

FIG. 21 is a graph showing the antiferroelectric positive up negative down (AFE-PUND) method;

FIGS. 22A, 22B, and 22C are a J-V graph, a voltage-dependent dielectric constant graph, and a P-V graph measured by an AFE-PUND method; and

FIG. 23 is a schematic diagram showing the crystallographic structure of TiN grown to the (111) crystal plane and a summary of the disclosure.

### DETAILED DESCRIPTION

Hereinafter, the disclosure will be described with reference to the accompanying drawings. However, the disclosure may be implemented in various different forms, and therefore is not limited to the embodiments described herein. In addition, in order to clearly describe the disclosure in the drawings, parts that are not related to the description are omitted, and similar parts are given similar drawing reference numerals throughout the specification.

In the entire specification, when a part is said to be “connected (linked, contacted, coupled)” to another part, this includes not only the case where it is “directly connected” but also the case where it is “indirectly connected” with another member in between. In addition, when a part is said to “include” a certain component, this does not mean that other components are excluded unless otherwise specifically stated, but that other components may be additionally provided.

The terms used in this specification are used only to describe specific embodiments and are not intended to limit the disclosure. The singular expression includes the plural expression unless the context clearly indicates otherwise. In this specification, the terms “include” or “have” are intended to specify the presence of a feature, number, step, operation, component, part, or combination thereof described in the specification, but should be understood as not excluding in advance the possibility of the presence or addition of one or more other features, numbers, steps, operations, components, parts, or combinations thereof.

Hereinafter, embodiments of the disclosure will be described in detail with reference to the accompanying drawings. For reference, the drawings may be exaggerated to some extent to illustrate the features of the disclosure. In this case, it is desirable to interpret them in light of the entire intent of this specification.

A capacitor according to an embodiment of the disclosure will be described.

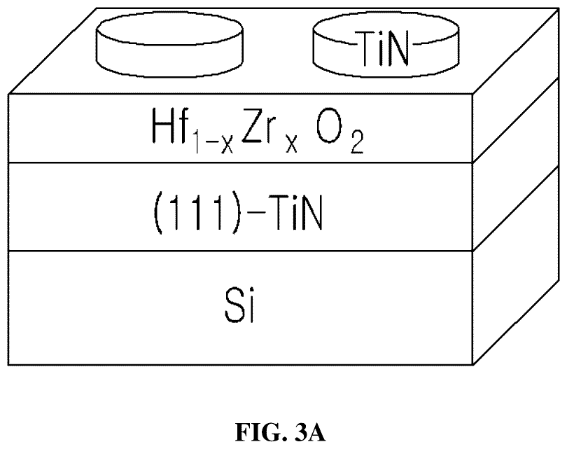

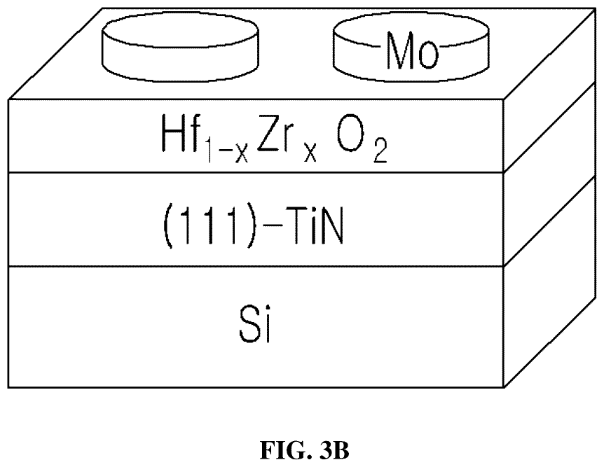

FIGS. 3A and 3B are each a schematic diagram showing a capacitor according to an embodiment of the disclosure when the upper electrode is TiN or Mo.

Referring to FIGS. 3A and 3B, a capacitor according to an embodiment of the disclosure may include: a silicon substrate; a lower electrode positioned on the silicon substrate, and including a titanium nitride with a preferred orientation control; a dielectric layer positioned on the lower electrode, and including a hafnium-zirconium composite oxide; and an upper electrode positioned on the dielectric layer.

In the disclosure, a “capacitor” means a device capable of storing electric capacity as electric potential energy in an electric circuit, and may have a structure in which two conductive plates are separated, but is not limited to the structure. In addition, the capacitor may be applied to a semiconductor device and a computing system based on the same, and specifically, may be applied to a logic-in-memory computing system. In addition, the capacitor may include a gate stack such as a ferroelectric field-effect transistor (FeFET), a ferroelectric tunnel junction (FTJ) device, etc.

According to an embodiment of the disclosure, the silicon substrate may serve as a channel for transferring charges.

The silicon substrate may mean a substrate made of silicon atoms, and further, the silicon substrate may mean a silicon substrate with p-type doping.

Meanwhile, the capacitor of the disclosure may have a lower electrode including titanium nitride (TiN) with preferred orientation control positioned on the silicon substrate.

At this time, the preferred orientation of the titanium nitride may be preferred to the (1,1,1) crystal plane.

Preferred orientation refers to a state in which atoms, molecules, or crystal grains are aligned in a specific direction in a material thin film or crystal structure, and this indicates a structure designed to improve physical, electrical, or optical properties in a specific direction.

At this time, the preferred orientation direction exists in various directions such as (100), (111), (110), etc., and in the case of the disclosure, it is preferred to the (1,1,1) crystal plane.

At this time, if titanium nitride preferentially oriented in the (1,1,1) crystal plane is used as the lower electrode, this has the advantage of being able to implement an antiferroelectric that can be switched even at low voltages by preventing oxidation of the electrode that occurs during the atomic layer deposition method of the HZO thin film due to its nitrogen-terminated (N-terminated) crystal structure.

At this time, the thickness of the lower electrode including the preferred orientation-controlled titanium nitride having the aforementioned advantages may be 15 nm to 25 nm.

This is because, if the thickness of the lower electrode is less than 15 nm, a problem of weak orientation may occur due to low crystallinity, and accordingly, the thickness of the lower electrode may be 15 nm or more, and more preferably 15 nm to 25 nm.

Meanwhile, a dielectric layer including a hafnium-zirconium composite oxide may be positioned on the titanium nitride.

At this time, the hafnium-zirconium composite oxide may be represented by Chemical Formula 1.

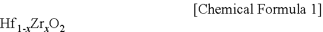

The X satisfies 0.7≤X<1.

At this time, the characteristics of the ferroelectric phase may vary depending on the value of the X, wherein when the X is less than 0.7, the ferroelectric phase may be preferentially stabilized, and when the X is 0.7 or more, the electric field-induced ferroelectric phase may be preferentially stabilized.

In the disclosure, the electric field-induced ferroelectric phase should be preferentially stabilized, so it is preferable that the value of the X is 0.7 or more.

The hafnium-zirconium composite oxide may be a polycrystalline material in which zirconium is added as a dopant based on the crystal structure of hafnium oxide (HfO₂), and the dielectric layer may be antiferroelectric. A material exhibiting antiferroelectricity may mean that adjacent dipoles are arranged in opposite orientations, unlike a ferroelectric material in which adjacent dipoles are arranged in the same orientation in a crystal structure in which dipoles are arranged, and may show a graph of a double loop in a polarization-voltage curve.

The thickness of the dielectric layer may be 4.5 nm to 5.3 nm, and this is because if the thickness of the dielectric layer is less than 4.5 nm, a problem of exhibiting degraded antiferroelectricity or amorphous thin film characteristics may occur, and if it exceeds 5.3 nm, a problem of not exhibiting electric field-induced ferroelectricity at low voltage may occur.

Meanwhile, an upper electrode may be located on the dielectric layer.

At this time, the upper electrode may be a metal electrode, and preferably, the upper electrode may include at least one member from the group consisting of titanium nitride and molybdenum.

At this time, the upper electrode may be connected to an external power source to perform a role of allowing the dielectric layer to receive an electric field from the outside.

The upper electrode may be formed along the surface of the dielectric layer, and its shape may include, but is not limited to, a planar structure, a spherical structure, a fin structure, a cup structure, a pillar structure, a cylinder structure, etc.

The thickness of the upper electrode is not particularly limited, and may be, for example, about 50 nm, and when the thickness within the range is satisfied, the dielectric layer may receive an electric field better from an external power source, so that the electrical performance of the capacitor may be further improved.

Hereinafter, a manufacturing method of a capacitor that achieves the above-described effect will be described.

A capacitor manufacturing method according to an embodiment of the disclosure will be described.

The capacitor manufacturing method according to the disclosure can apply all of the contents described for the above-described capacitor, and although detailed descriptions of overlapping parts have been omitted, the same can be applied even if the descriptions are omitted.

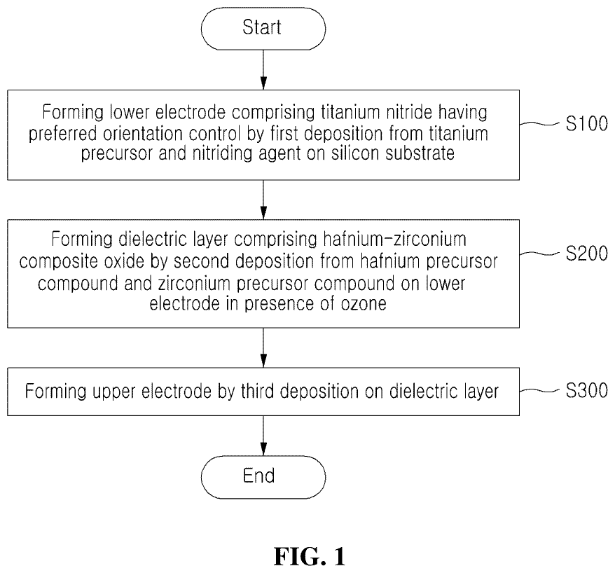

FIG. 1 is a flow chart showing the steps of a capacitor manufacturing method according to an embodiment of the disclosure.

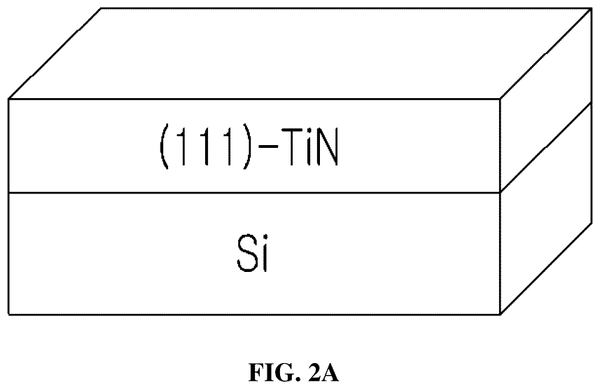

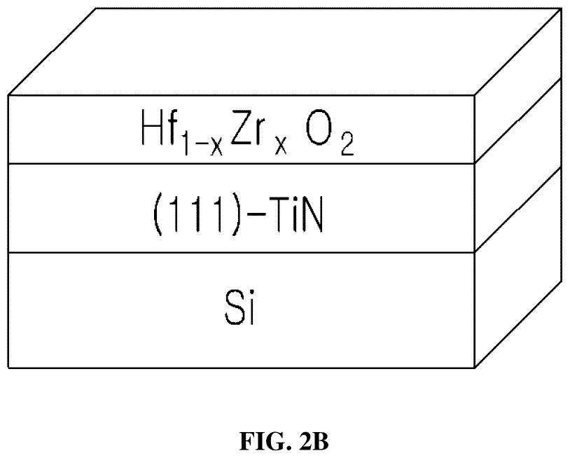

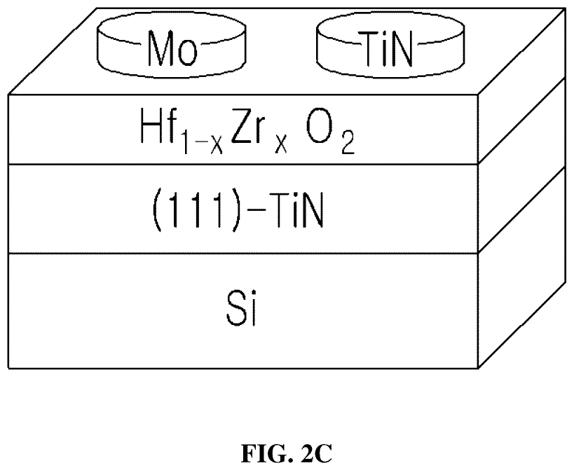

FIGS. 2A, 2B, and 2C are each a schematic diagram showing the process of a capacitor manufacturing method according to an embodiment of the disclosure.

Referring to FIGS. 1 and 2, a capacitor manufacturing method according to an embodiment of the disclosure may include: (S100) forming a lower electrode including titanium nitride with a preferred orientation control by first deposition from a titanium precursor and a nitriding agent on a silicon substrate; (S200) forming a dielectric layer including a hafnium-zirconium composite oxide by second deposition from a hafnium precursor compound and a zirconium precursor compound on the lower electrode in the presence of ozone; and (S300) forming an upper electrode by third deposition on the dielectric layer.

The first step may include forming a lower electrode including titanium nitride with a preferred orientation control by first deposition from a titanium precursor and a nitriding agent on a silicon substrate. (S100)

For example, the titanium precursor may be a [(CH₃)₂N]₄Ti precursor, and the nitriding agent may be NH₃/Ar plasma.

At this time, the first deposition can be performed by a plasma atomic layer deposition method.

At this time, the preferred orientation-controlled titanium nitride may be titanium nitride that has been preferentially grown to a (1,1,1) crystal plane, and the titanium nitride may be the lower electrode.

The second step may include forming a dielectric layer including a hafnium-zirconium composite oxide by a second deposition from a hafnium precursor compound and a zirconium precursor compound on the lower electrode in the presence of ozone. (S200)

The ozone may be used as an oxidizing agent.

As an example, the hafnium precursor compound may be [(CH₃)(C₂H₅)N]₄H, and the zirconium precursor compound may be [(CH₃)(C₂H₅)N]₄Zr as a precursor.

At this time, the hafnium-zirconium composite oxide may be represented by Chemical Formula 1.

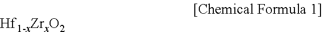

(the X satisfies 0.7≤x<1).

Meanwhile, the second deposition may be performed by a thermal atomic layer deposition method at a temperature of 200° C. to 300° C.

At this time, if the thermal atomic layer deposition method is performed at a temperature below 200° C., a problem of exhibiting amorphous thin film characteristics even after heat treatment may occur, and if this is performed at a temperature exceeding 300° C., a problem of not occurring a self-control reaction may occur, so it is preferable to perform this within the temperature range described above, and more preferably, the range may be 250° C. to 300° C.

Through this, the thickness of the dielectric layer including the manufactured hafnium-zirconium composite oxide may be preferably 4.5 nm to 5.3 nm.

The third step may include forming an upper electrode by a third deposition on the dielectric layer. (S300)

At this time, the third deposition may be performed by a sputtering method using plasma power.

The conditions of the sputtering method using plasma power are, for example, under the conditions of a base pressure of 0.5×10⁻⁶ Torr to 2×10⁶ Torr and a working pressure of 0.5×10⁻³ Torr to 2×10⁻³ Torr, in the case of RF sputtering, a plasma power of 150 W to 250 W may be used for 10 to 20 minutes, and in the case of DC sputtering, a plasma power of 100 W to 200 W may be used for 3 to 10 minutes to form an upper electrode of 40 nm to 60 nm.

For example, a TiN upper electrode may be deposited by RF sputtering or a Mo upper electrode may be deposited by DC sputtering.

Meanwhile, the upper electrode may be manufactured using a mask (shadow mask) which is a spherical pattern with a diameter of 150 to 250 um.

An additional process may be performed after the manufacturing step described above, and specifically, after forming of the upper electrode, performing an annealing process after metallization at a temperature of 400° C. to 500° C. for 30 to 300 seconds may be further included.

At this time, the process may preferably be performed in a nitrogen atmosphere.

At this time, the reason for performing the annealing process after metallization under the conditions described above is for crystallization of the dielectric.

The capacitor of the disclosure may be manufactured through the manufacturing method described above.

Hereinafter, the disclosure will be described in more detail through examples and experimental examples. These examples and experimental examples are intended only to illustrate the disclosure, and the scope of the disclosure is not limited by these examples and experimental examples.

### Example: Capacitor Manufacturing

FIGS. 2A, 2B, and 2C are each a schematic diagram showing the process of a capacitor manufacturing method according to an embodiment of the disclosure.

An explanation will be made with reference to FIG. 2.

Referring to FIG. 2A, first, using plasma atomic layer deposition (PEALD) on a p-type doped Si substrate, a TiN lower electrode was first grown to a (111) crystal plane by using [(CH₃)₂N]₄Ti precursor and NH₃/Ar plasma as a nitriding agent, and a 20 nm thick TiN lower electrode was deposited.

Next, referring to FIG. 2B, using thermal atomic layer deposition, [(CH₃)(C₂H₅)N]₄Hf as a hafnium oxide precursor, [(CH₃)(C₂H₅)N]₄Zr as a zirconium oxide precursor, and ozone (O₃) as an oxidizing agent, a 4.5 nm to 5.3 nm thick Hf₁₋ₓZrₓO₂ (x>0.7) thin film was grown.

At this time, the TiN upper electrode was deposited on the Hf₁₋ₓZrₓO₂ dielectric thin film by RF sputtering, or the Mo upper electrode was deposited using DC sputtering.

Referring to FIG. 2C, for the deposition of the upper electrode with a thickness of 50 nm, the conditions of 1×10⁻⁶ Torr as the base pressure and 1×10⁻³ Torr as the working pressure were used, and in the case of RF sputtering, 200 W of plasma power was used for 15 minutes, and in the case of DC sputtering, 50 nm was deposited for 5 minutes with 150 W of plasma power.

At this time, the upper electrode was manufactured using a mask (shadow mask) that is a spherical pattern with a diameter of 200 μm.

Finally, the post-metallization annealing (PMA) treatment for the above results was performed under the conditions of 400° C. for 300 seconds or 500° C. for 30 seconds in a nitrogen (N2) atmosphere.

Thus, a capacitor utilizing the preferred orientation-controlled titanium nitride was manufactured.

### Experimental Example 1: Confirmation of TiN Characteristics

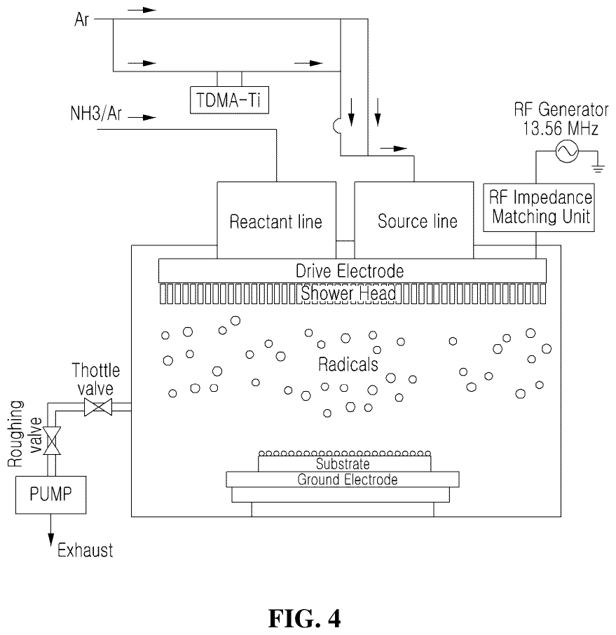

FIG. 4 is a schematic diagram showing a PEALD process for depositing TiN electrodes.

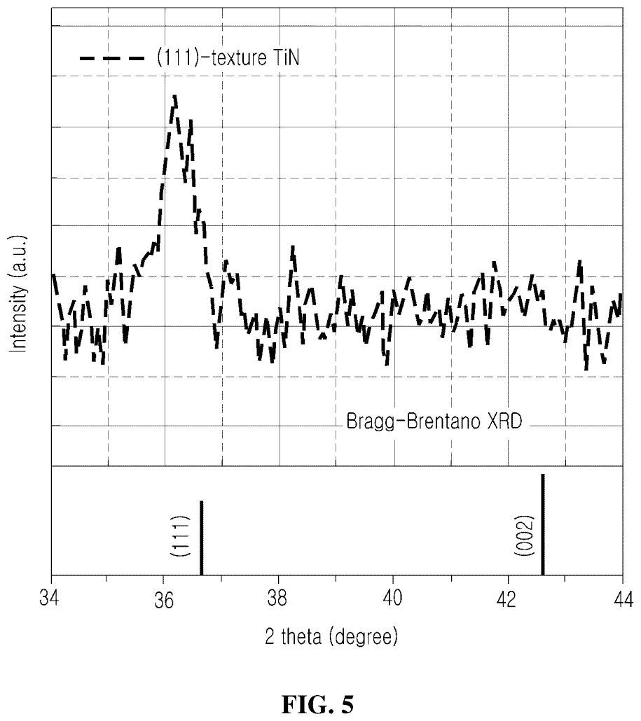

FIG. 5 is an XRD graph confirming the orientation of the formed TiN electrode.

Referring to FIGS. 4 and 5, Bragg Brentano XRD measurements were performed as above to confirm the crystallinity of the TiN lower electrode deposited via PEALD.

At this time, the thickness of the deposited TiN electrode is 20 nm, the resistivity is 300 μΩ*cm, and it can be confirmed that this has a preferred orientation in the (111) crystal plane.

### Experimental Example 2: Confirmation of 5.2 nm-Hf₁₋ₓZrₓO₂ Characteristics

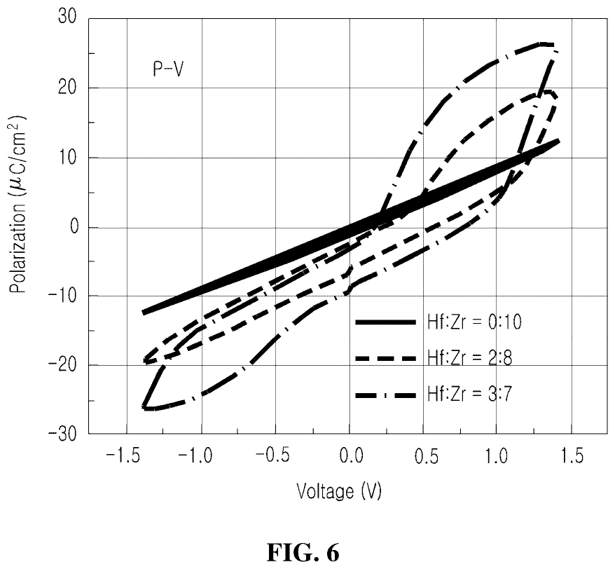

FIG. 6 is a P-V graph when the upper electrode is TiN in 5.2 nm-Hf₁₋ₓZrₓO₂.

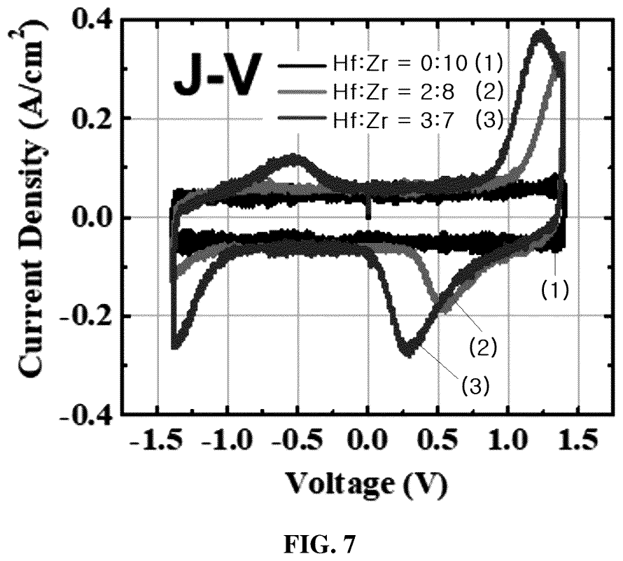

FIG. 7 is a J-V graph when the upper electrode is TiN in 5.2 nm-Hf₁₋ₓZrₓO₂.

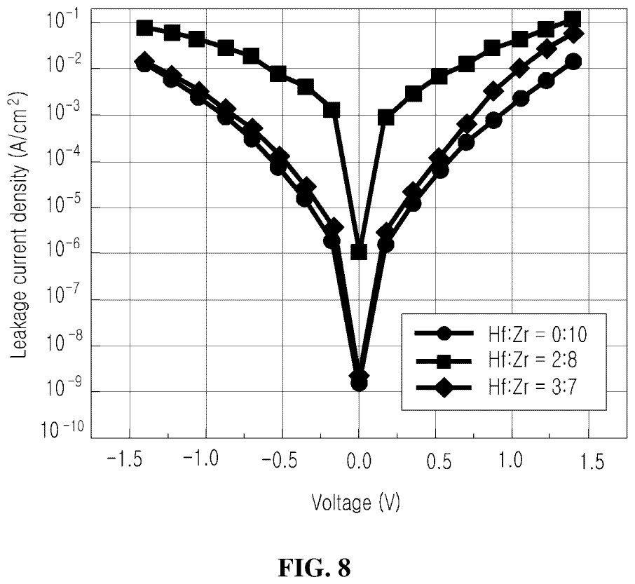

FIG. 8 is a leakage current density graph according to voltage when the upper electrode is TiN in 5.2 nm-Hf₁₋ₓZrₓO₂.

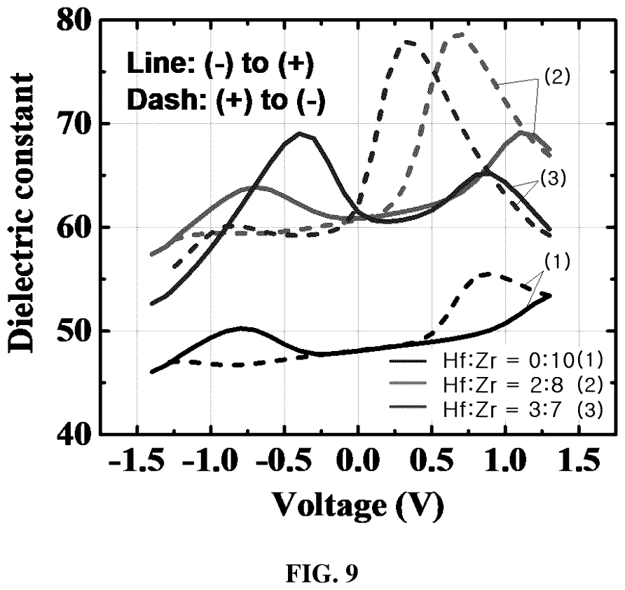

FIG. 9 is a graph of the dielectric constant as a function of voltage when the upper electrode is TiN in 5.2 nm-Hf₁₋ₓZrₓO₂.

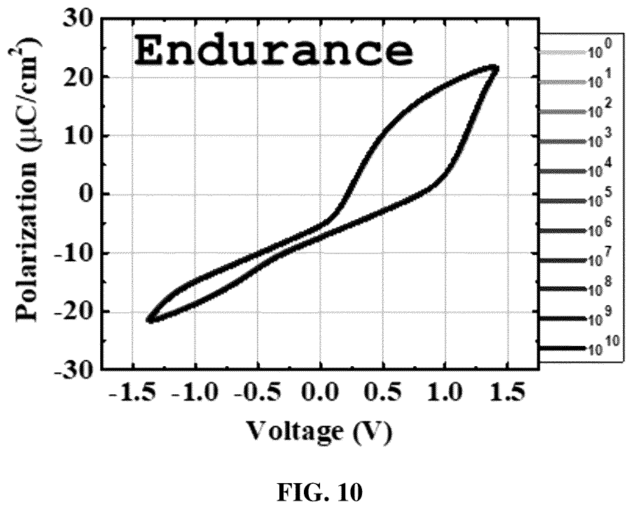

FIG. 10 is a P-V graph analyzing the endurance characteristics when the upper electrode is TiN in 5.2 nm-Hf₁₋ₓZrₓO₂.

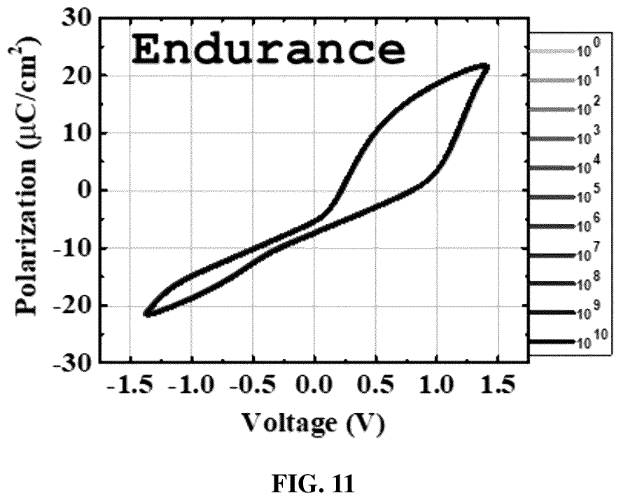

FIG. 11 is a J-V graph analyzing the endurance characteristics when the upper electrode is TiN in 5.2 nm-Hf₁₋ₓZrₓO₂.

Referring to FIG. 6 to FIG. 11, antiferroelectric behavior can be confirmed in a 5.2 nm thick Hf1-xZrxO2 thin film grown on TiN oriented to the (111) crystal plane when TiN is used as the upper electrode.

At this time, as the composition ratio of Hf increases, the voltage at which polarization switching occurs decreases, and it can be confirmed that sufficient polarization switching is observed even at a voltage of 1.4 V in the Hf_{0.3}Zr_{0.7}O₂ thin film.

Meanwhile, on the C-V graph, the dielectric constant of the Hf_{0.3}Zr_{0.7}O₂ and Hf_{0.2}Zr_{0.8}O₂ thin films is 60 based on 0 V, which is 0.34 nm when converted to EOT.

In addition, the endurance result measured by applying a 1 MHz square wave confirms that no breakdown occurs up to 10¹⁰ cycles.

The above high permittivity and durability can be inferred to be due to the excellent interfacial properties between the electrode and thin film grown via PEALD.

### Experimental Example 3: Confirmation of 4.5 nm-Hf₁₋ₓZrₓO₂ Characteristics

FIGS. 3A and 3B are each a schematic diagram showing a capacitor according to an embodiment of the disclosure when the upper electrode is TiN or Mo.

First, confirmed was the case where the upper electrode was TiN, as in FIG. 3A.

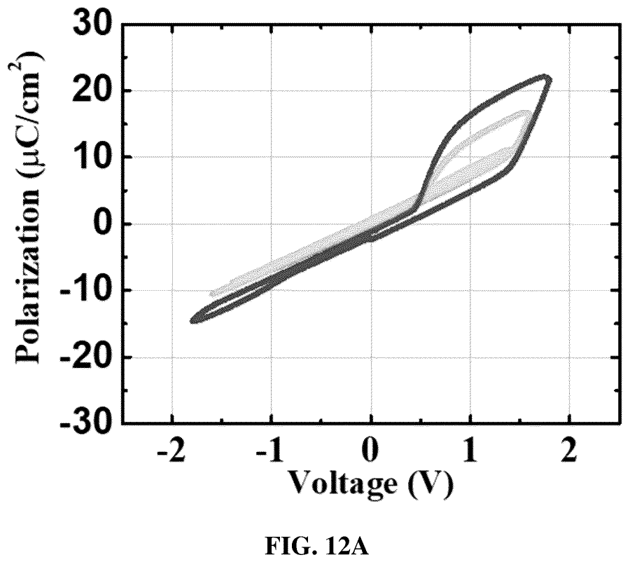

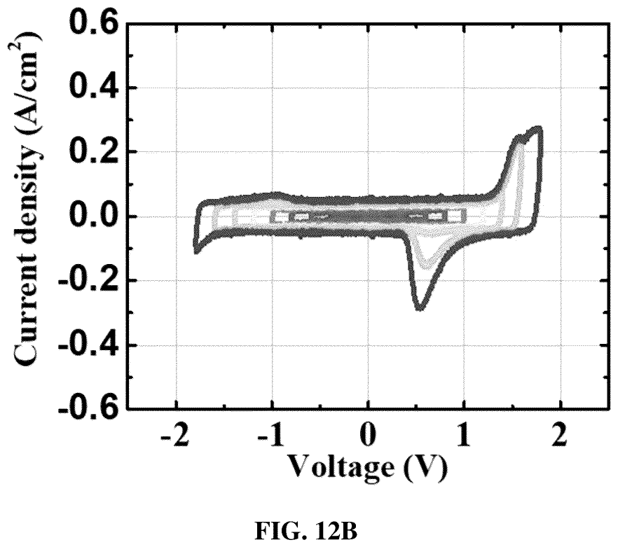

FIGS. 12A and 12B are a P-V graph and a J-V graph when the upper electrode is TiN in 4.5 nm-Hf₁₋ₓZrₓO₂ and X is 0.9.

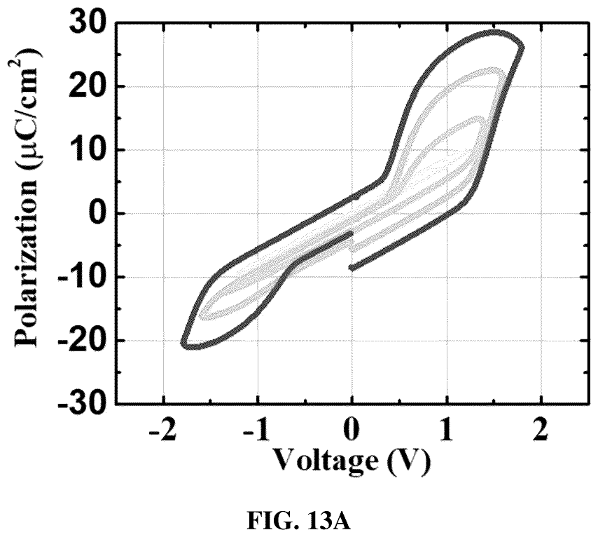

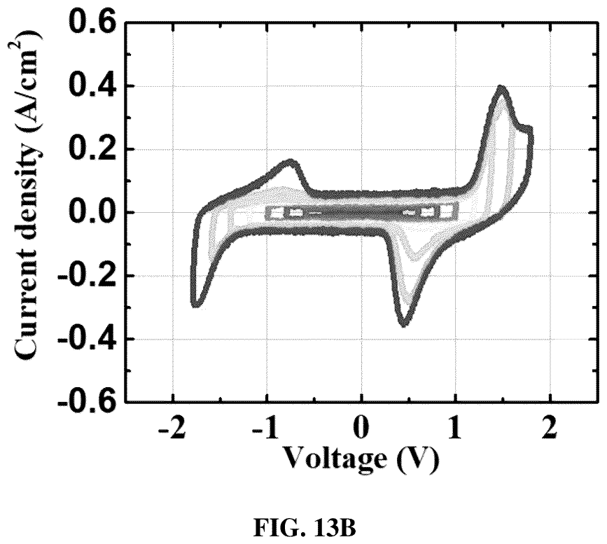

FIGS. 13A and 13B are a P-V graph and a J-V graph when the upper electrode is TiN in 4.5 nm-Hf₁₋ₓZrₓO₂ and X is 0.8.

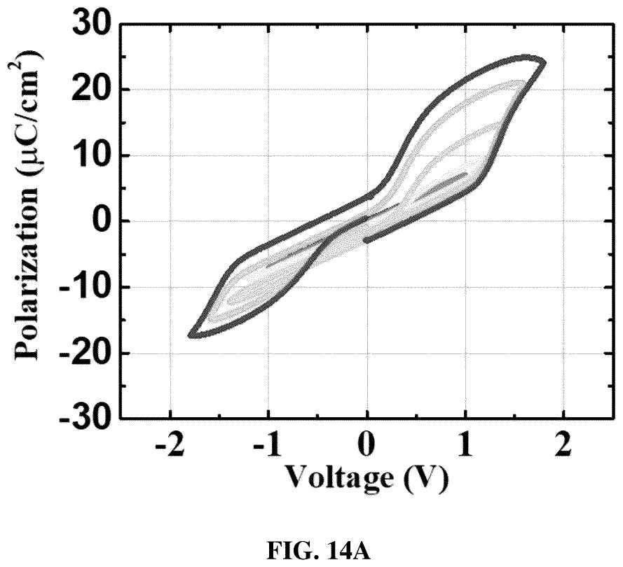

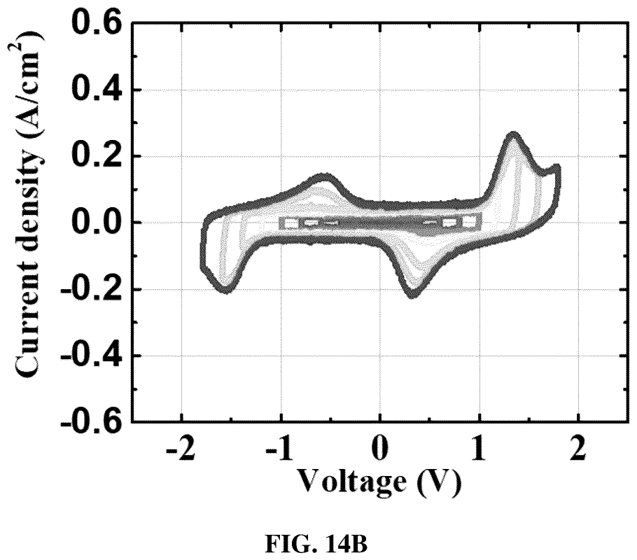

FIGS. 14A and 14B are a P-V graph and a J-V graph when the upper electrode is TiN in 4.5 nm-Hf₁₋ₓZrₓO₂ and X is 0.7.

Referring to FIGS. 12A and 12B and FIGS. 14A and 14B, even in the Hf₁₋ₓZrₓO₂ thin film with a thickness of 4.5 nm, which is thinner than 5.2 nm, when the upper electrode is TiN, it is possible to confirm the antiferroelectric behavior in which the spontaneous polarization is close to 0 when no electric field is present and the polarization switching occurs when an electric field is applied.

Next, the case in which the upper electrode is Mo, as in FIG. 3B, was confirmed.

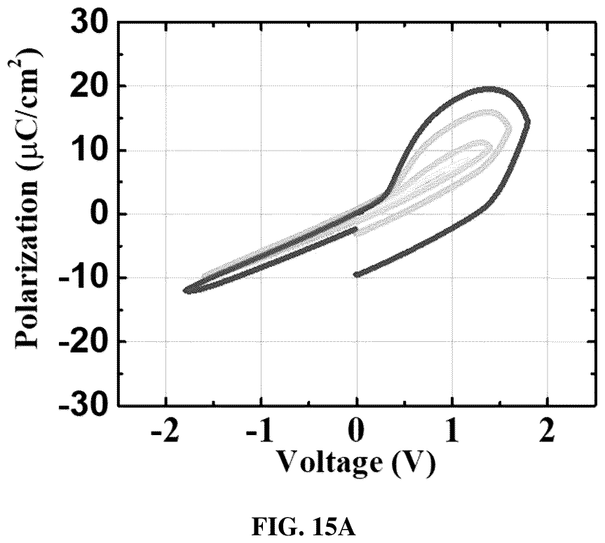

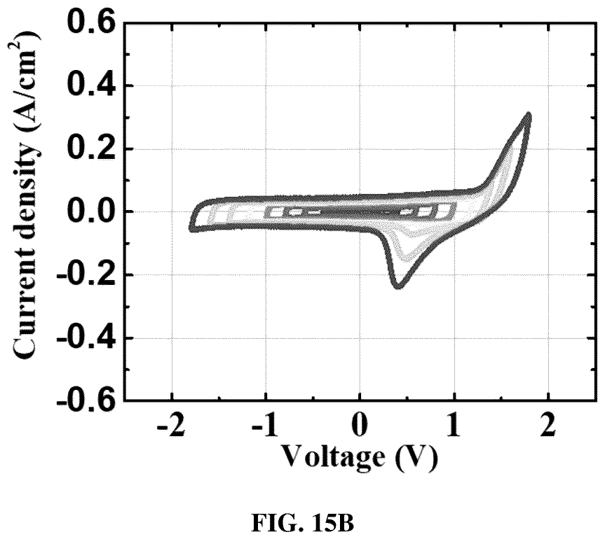

FIGS. 15A and 15B are a P-V graph and a J-V graph when the upper electrode is Mo and X is 0.9 in 4.5 nm-Hf₁₋ₓZrₓO₂.

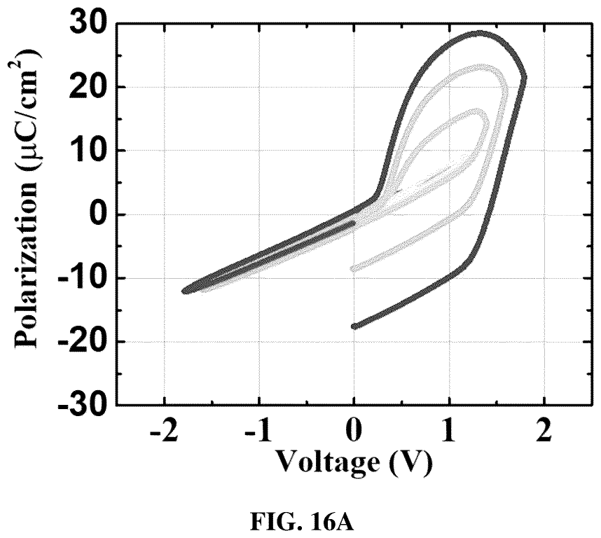

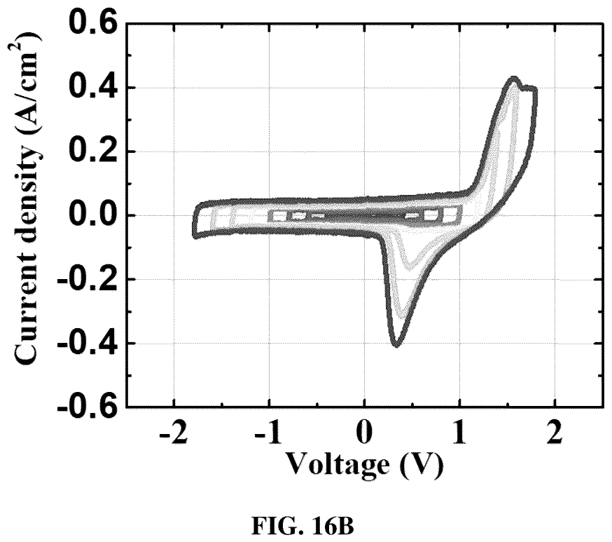

FIGS. 16A and 16B are a P-V graph and a J-V graph when the upper electrode is Mo and X is 0.8 in 4.5 nm-Hf₁₋ₓZrₓO₂.

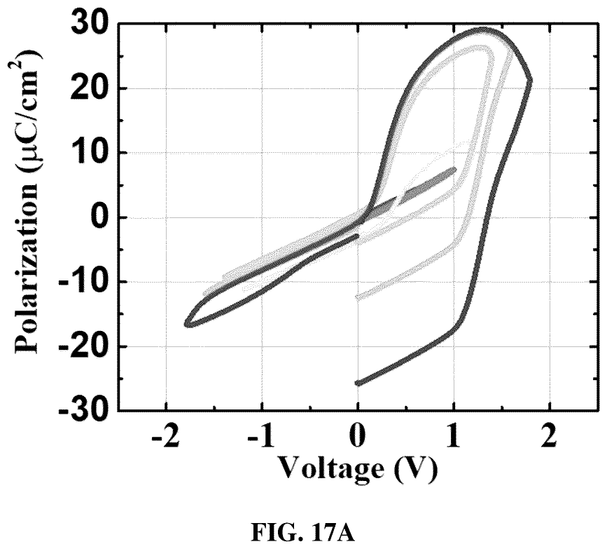

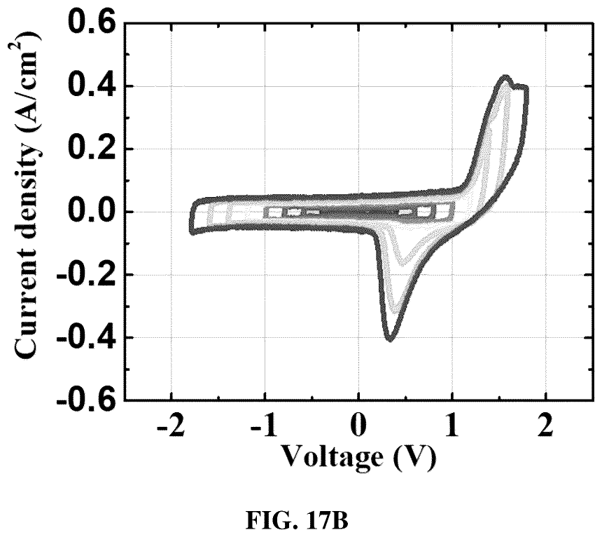

FIGS. 17A and 17B are a P-V graph and a J-V graph when the upper electrode is Mo and X is 0.7 in 4.5 nm-Hf₁₋ₓZrₓO₂.

Referring to FIGS. 15A and 15B and FIGS. 17A and 17B, antiferroelectric behavior can be confirmed when Mo is used as the upper electrode in a 4.5 nm thick Hf₁₋ₓZrₓO₂ thin film. However, compared to when TiN is used as the upper electrode, the antiferroelectric polarization switching behavior can be confirmed in the positive voltage region due to the shift in the negative voltage direction due to the difference in work function caused by using a different lower electrode.

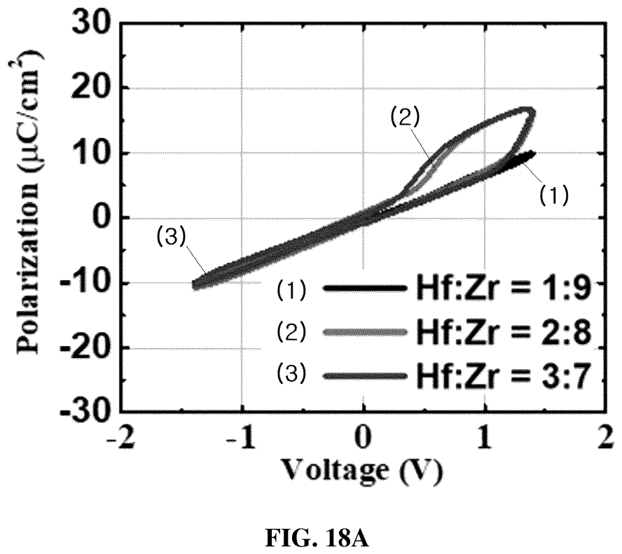

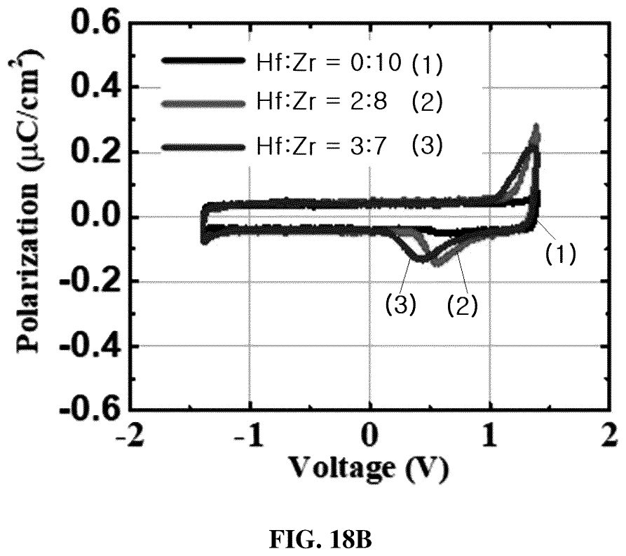

FIGS. 18A and 18B are a P-V and a J-V graph at a voltage of 1.4 V when the upper electrode is TiN and X is 0.7-0.9 in 4.5 nm-Hf₁₋ₓZrₓO₂.

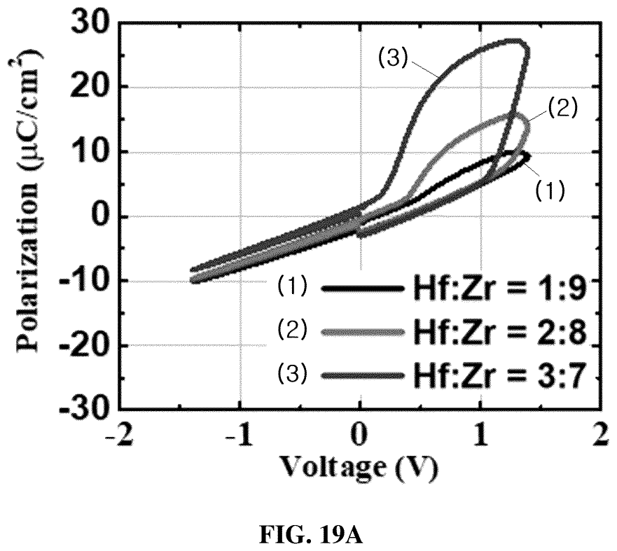

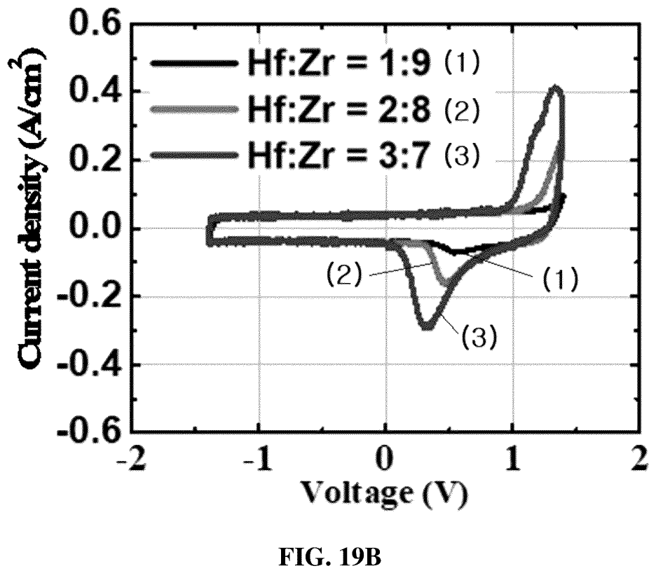

FIGS. 19A and 19B are a P-V and a J-V graph at a voltage of 1.4 V when the upper electrode is Mo and X is 0.7-0.9 in 4.5 nm-Hf₁₋ₓZrₓO₂.

Referring to FIGS. 18A and 18B and FIGS. 19A and 19B, the P-V and J-V graphs at 1.4 V for Hf₁₋ₓZrₓO₂ thin films grown on TiN oriented to the (111) crystal plane can be confirmed according to the type of upper electrode.

At this time, it can be seen that when the Mo upper electrode is used, a high electric field polarization may be induced at a low voltage (1.4 V) compared to when the TiN upper electrode is used.

In addition, it can be confirmed that the voltage at which the electric field-induced polarization switching occurs tends to decrease as the composition ratio of Hf increases.

In addition, it can be confirmed that sufficient polarization switching may occur at 1.4 V even when the film thickness is reduced to 4.5 nm.

### Experimental Example 4: Electric Field Polarization Experiment Excluding Leakage Current

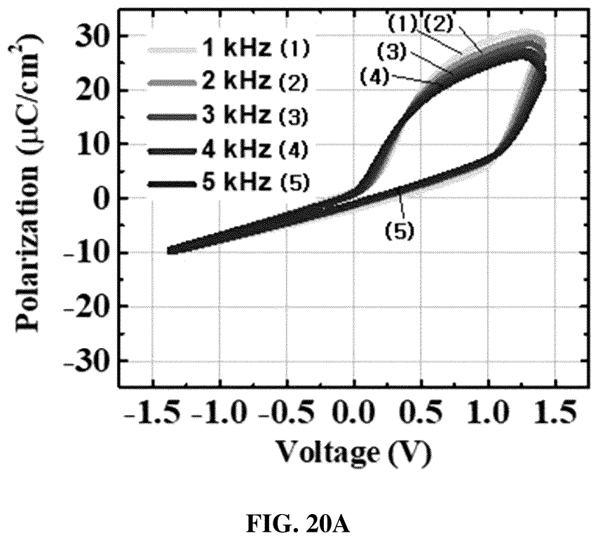

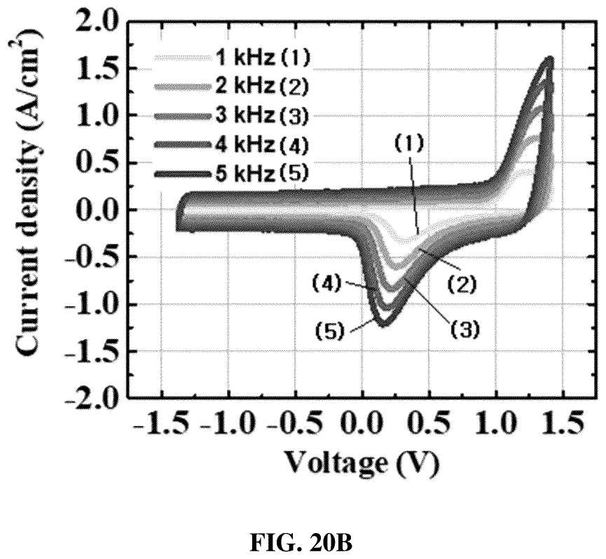

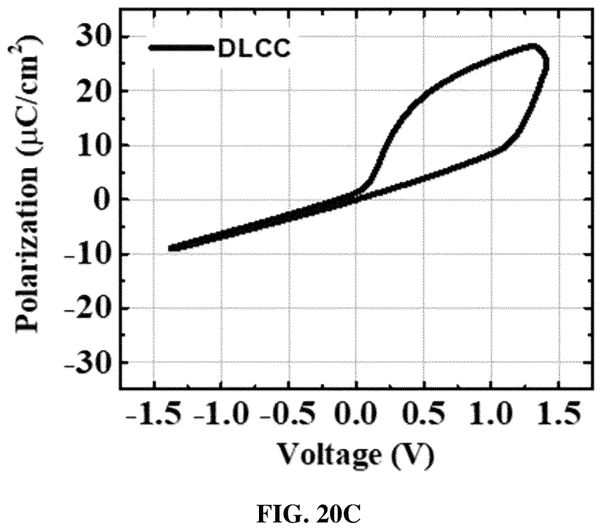

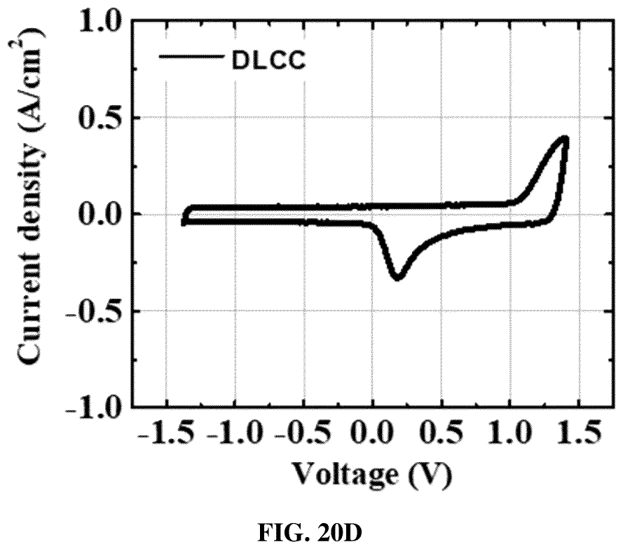

FIGS. 20A, 20B, 20C, and 20D are P-V, J-V graphs extracted using the dynamic leakage current compensation (DLCC) method.

Referring to FIGS. 20A, 20B, 20C, and 20D, the dynamic leakage current compensation method was used to extract only the effect of polarization switching, excluding the influence of leakage current in the electric field polarization that appeared in the Mo/Hf_{0.3}Zr_{0.7}O₂/(111)-TiN thin film.

At this time, the dynamic leakage current compensation method may be calculated by Equation 1 below.

$${i}_{comp} ( ω ) = \frac{ω}{{ω}_{2} - {ω}_{1}} [ i ( {ω}_{2} ) - i ( {ω}_{1} ) ] \qquad [ Equation 1 ]$$

$$\begin{matrix}{P}_{comp} ( ω ) = \frac{ω}{\dot{V}} \cdot \frac{q}{{ω}_{2} - {ω}_{1}} ( {\dot{V}}_{2} {P}_{2}^{′} - {\dot{V}}_{1} {P}_{1}^{′} ) \\ = \frac{1}{{ω}_{2} - {ω}_{1}} ( {ω}_{2} {P}_{2}^{′} - {ω}_{1} {P}_{1}^{′} )\end{matrix} .$$

Referring again to FIGS. 20A, 20B, 20C, and 20D, it can be seen that the thin film is less affected by leakage current and may induce an electric field polarization of 25.17 μC/cm² even at 1.4 V from the i_{comp} and P_{comp} values obtained from the polarization-voltage and current density-voltage measured at various frequencies.

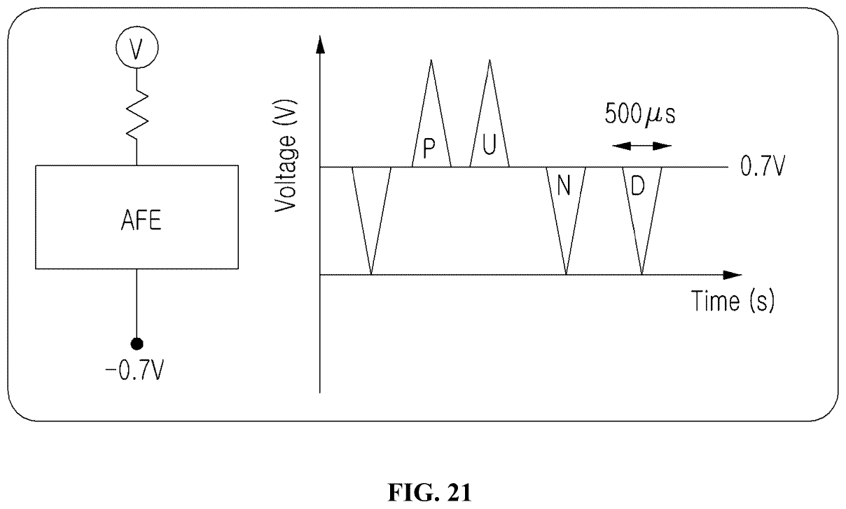

FIG. 21 is a graph showing the antiferroelectric positive up negative down (AFE-PUND) method.

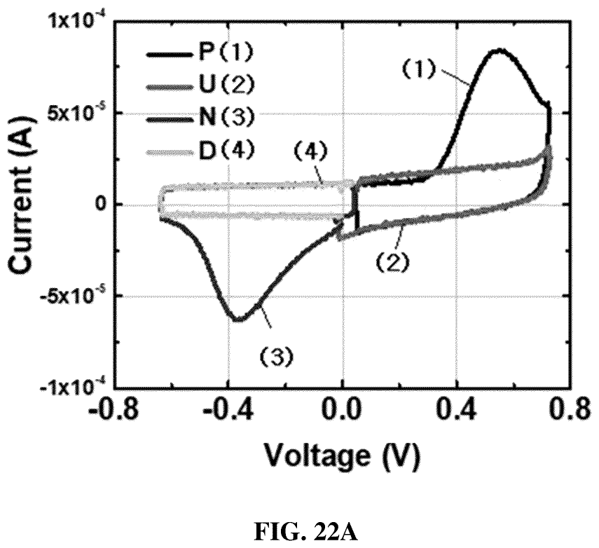

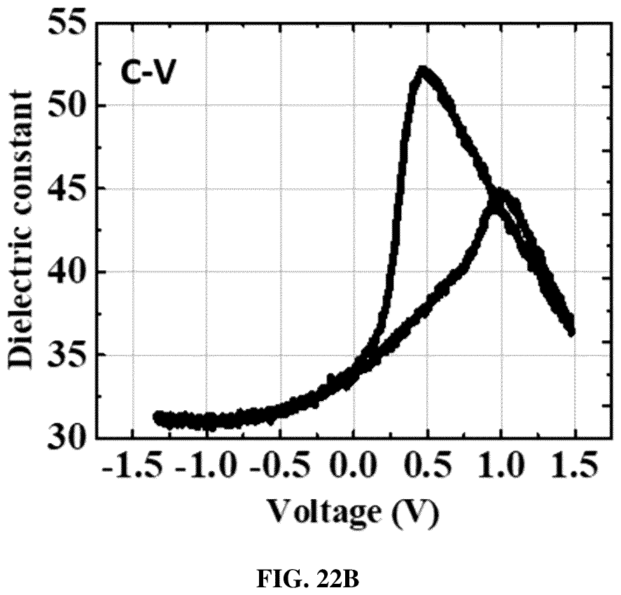

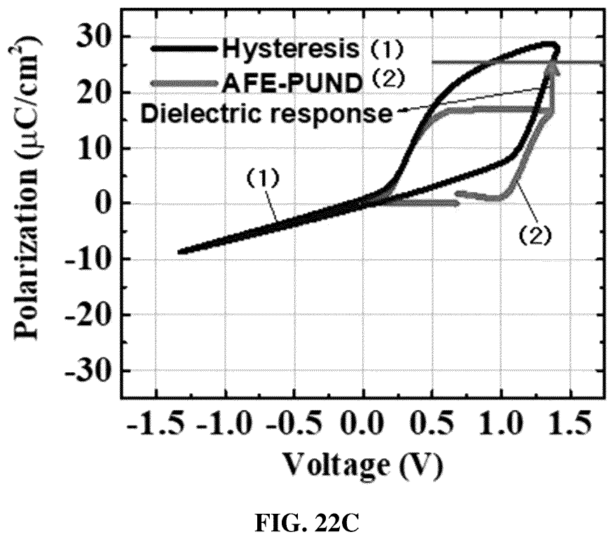

FIGS. 22A, 22B, and 22C are a J-V graph, a voltage-dependent dielectric constant graph, and a P-V graph measured by an AFE-PUND method.

Referring to FIG. 21 and FIGS. 22A, 22B, and 22C, the PUND method is a method for measuring the residual polarization excluding the leakage current in a ferroelectric thin film, and thus this was to e applied to an antiferroelectric.

PUND was performed on the upper electrode while applying an offset voltage of −0.7 V to the lower electrode of the capacitor to extract the switching due to the electric field polarization.

Afterwards, it can be seen that the electric field polarization of 25.04 μC/cm2 may be induced even at 1.4 V by adding the dielectric response to the capacitance extracted through the capacitance-voltage.

At this time, the polarization value due to the dielectric response may be calculated by Equation 2 below.

$$P = \frac{{ε}_{HZO} * {ε}_{0} * V}{d} \qquad [ Equation 2 ]$$

At this time, ε_{HZO}: HZO dielectric constant, ε₀: vacuum permittivity, d: HZO thickness and V: applied voltage.

### Experimental Example 5: Comprehensive Summary

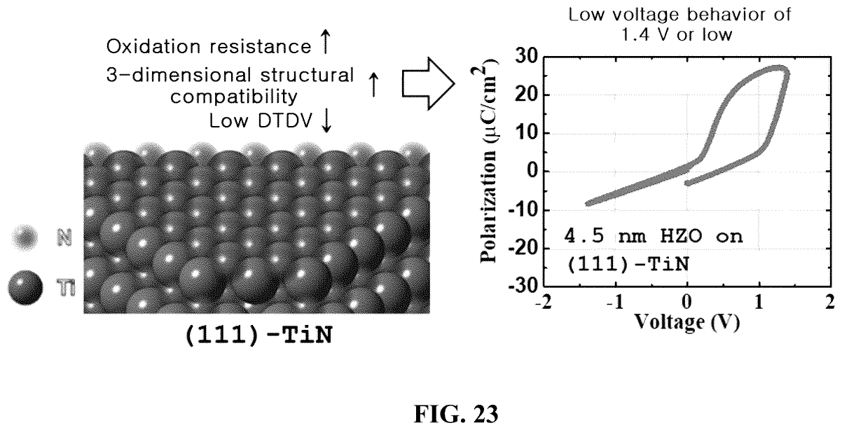

FIG. 23 is a schematic diagram showing the crystallographic structure of TiN grown with (111) crystal plane and a summary of the study.

Referring to FIG. 23, the disclosure explored antiferroelectricity in an atomic layer deposition-based TiN electrode having a preferred orientation in the (111) crystal plane.

Through the experimental examples described above, it was confirmed that when the upper electrode was used as Mo, an electric field polarization of 25 μc/cm² or more at 1.4 V could be induced in a 4.5 nm thick Hf_{0.3}Zr_{0.7}O₂ thin film.

This shows that when the lower electrode having a preferred orientation in the (111) crystal plane is used, this has a nitrogen-terminated (N-terminated) crystal structure as shown in the figure above, preventing oxidation of the electrode that occurs during the atomic layer deposition of the HZO thin film, and thus enabling the implementation of an antiferroelectric that is switchable even at low voltages.

In addition, the technology can minimize device-to-device variation that occurs in polycrystalline HZO thin films due to device miniaturization, and is a future semiconductor technology that may be applied to three-dimensional structures and is suitable for back-end-of-line processes that require process temperatures below 400° C.

The technology is expected to be applicable to high-k thin films, (anti) ferroelectric thin films, and spin logic devices.

The description of the disclosure is for illustrative purposes, and those skilled in the art will understand that it can be easily modified into other specific forms without changing the technical idea or essential features of the disclosure. Therefore, the embodiments described above should be understood as being exemplary in all respects and not limiting. For example, each component described as a single type may be implemented in a distributed manner, and likewise, components described as distributed may be implemented in a combined form.

The scope of the disclosure is indicated by the following claims, and all changes or modifications derived from the meaning and scope of the claims and their equivalent concepts should be interpreted as being included in the scope of the disclosure.

1. A capacitor comprising:
a silicon substrate;
a lower electrode positioned on the silicon substrate, the lower electrode including a preferred orientation-controlled titanium nitride;
a dielectric layer including a hafnium-zirconium composite oxide positioned on the lower electrode; and
an upper electrode positioned on the dielectric layer.

2. The capacitor of claim 1, wherein
a preferred orientation of the titanium nitride is oriented along a (1,1,1) crystal plane.

3. The capacitor of claim 1, wherein
the hafnium-zirconium composite oxide is represented by Chemical Formula 1: 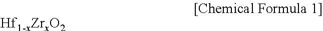
wherein the x is greater than or equal to 0.7 and less than 1.

4. The capacitor of claim 1, wherein
the dielectric layer is antiferroelectric.

5. The capacitor of claim 1, wherein
a thickness of the lower electrode is in a range of 15 nm to 25 nm.

6. The capacitor of claim 1, wherein
a thickness of the dielectric layer is in a range of 4.5 nm to 5.3 nm.

7. The capacitor of claim 1, wherein
the upper electrode comprises at least one from a group consisting of titanium nitride and molybdenum.

8. A method for manufacturing a capacitor, the method comprising:
forming a lower electrode comprising a preferred orientation-controlled titanium nitride by a first deposition from a titanium precursor and a nitriding agent on a silicon substrate;
forming a dielectric layer comprising a hafnium-zirconium composite oxide by a second deposition from a hafnium precursor compound and a zirconium precursor compound on the lower electrode in a presence of ozone; and
forming an upper electrode by a third deposition on the dielectric layer.

9. The method of claim 8, wherein
a preferred orientation of the titanium nitride is oriented along a (1,1,1) crystal plane.

10. The method of claim 8, wherein
the hafnium-zirconium composite oxide is represented by Chemical Formula 1: 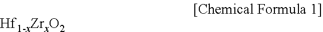
wherein the x is greater than or equal to 0.7 and less than 1.

11. The method of claim 8, wherein
in the forming the lower electrode,
the first deposition is performed using a plasma atomic layer deposition method.

12. The method of claim 8, wherein
in the forming the dielectric layer,
the second deposition is performed by a thermal atomic layer deposition method at a temperature range of 200° C. to 300° C.

13. The method of claim 8, wherein
in the forming the upper electrode,
the third deposition is performed by sputtering using plasma power.

14. The method of claim 8, further comprising
after the forming the upper electrode,
performing an annealing process after metallization for a duration ranging 30 to 300 seconds at a temperature range of 400 to 500° C.
